(19) United States
(12) Patent Application Publication
(10) Pub. No.: US 2006/0262684 A1
(43) Pub. Date: Nov. 23, 2006

(54) Multilayer optical disc having wobble pits

(76) Inventor: Johannes Henrikus Maria Spruit, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/549,637

(22) PCT Filed: Mar. 9, 2004
(86) PCT No.: PCT/IB04/50220

§ 371 Date: Sep. 20, 2005

(30) Foreign Application Priority Data
Mar. 24, 2003 (EP) 03100753.7

(51) Int. Cl. G11B 20/00

(52) U.S. Cl. 369/53.1

(57) ABSTRACT

A record carrier for recording information by writing marks in a track has a recording layer with a pregroove (51). The pregroove has a wobble that has wobble modulation (52) for representing control information. The pregroove further has a pregroove modulation constituted by pregroove pit areas (54) having a predefined width and depth alternating with pregroove land areas (53) having a reduced depth and/or width, in particular zero depth. A majority of the pregroove land areas (53) is located at zero crossings of the wobble and a majority of the pregroove pit areas is located at peak values of the wobble for optimizing the wobble signal strength. A scanning device has wobble detection means for retrieving the control information from the wobble modulation, and pregroove demodulation means for retrieving the recording control information from the pregroove modulation.

The invention relates to a record carrier of a writable type for recording information by writing marks in a track.

The invention further relates to a device for scanning the record carrier and a method for providing information via the record carrier.

An optical record carrier is known from WO00/43996. The record carrier comprises a guide groove, usually called pregroove, for indicating the position of tracks in which the information is to be represented in a predefined manner by recording optically readable marks. The pregroove is meandering by a periodic excursion of the track in a direction transverse to the longitudinal scanning direction (further denoted as wobble). The wobble comprises a wobble modulation, for example by inversing wobble periods in phase according to additional information such as addresses or recording control information. A scanning device is provided with a head for generating a beam of radiation for scanning the track. The marks are detected during said scanning by variations of the reflectivity of the scanned surface. The variations in intensity of the reflected radiation are detected by a main detector system. Furthermore the scanning device has auxiliary detectors for generating tracking servo signals based on pregroove for detecting a spatial deviation of the head with respect to the track. The tracking servo signals are used to control actuators to position the head on the track. The wobble modulation is detected via the auxiliary detectors for retrieving the additional information. A problem of the known record carrier and device is that the data capacity of the wobble modulation is limited, and the pregroove is not suitable for adjusting a focussing servo system.

Therefore it is an object of the invention to provide a record carrier and a scanning device providing a more versatile pregroove.

According to a first aspect of the invention the object is achieved with a record carrier of a writable type for recording information by writing marks in a track on a recording layer via a beam of radiation entering through an entrance face of the record carrier and constituting a scanning spot having an effective diameter on the track, the recording layer comprising a pregroove indicating the position of the track, the pregroove exhibiting a wobble constituted by periodical displacements of the pregroove in a direction transverse to the longitudinal direction of the track, the wobble exhibiting a wobble modulation for representing control information, and the pregroove comprising a pregroove modulation constituted by pregroove pit areas having a predefined width and depth alternating with pregroove land areas having a reduced depth and/or width, in particular zero depth, a majority of the pregroove land areas being located at zero crossings of the wobble and a majority of the pregroove pit areas being located at peak values of the wobble.

According to a second aspect of the invention the object is achieved with a device for scanning a track on the above mentioned record carrier via a beam of radiation, the device comprising a head for providing the beam, wobble detection means for retrieving the control information from the wobble modulation, and pregroove demodulation means for retrieving the recording control information from the pregroove modulation.

The effect of the measures is that the pregroove has a second type of modulation that can be detected from variations in the intensity of the reflected radiation. It is to be noted that an un-modulated pregroove does not provide intensity variations without written marks. The intensity variations due to the pregroove modulation can be detected via a main detector system that is available for detecting the marks representing main information, and can be used for adjusting a focusing servo system. By positioning the pregroove land areas around the zero crossings of the wobble the original wobble signal remains sufficiently high for the wobble detection means, in particular for wobble detection means in pre-existing scanning devices designed for a wobble without pregroove modulation. Advantageously the pregroove modulation can be produced by modulating or switching the laser during mastering the pregroove.

The invention is also based on the following recognition. A disadvantage of a pregroove land-pit pattern as compared to a regular pregroove without modulation is that the wobble signal is reduced because of the reduced duty cycle of the pregroove. A reduction of a factor of two in wobble signal could be expected by using a random pit pattern with 50% duty cycle. Moreover, apart from the decrease in signal level, the noise increases by the disturbing effects of the pit pattern. Both effects result in a decrease in wobble carrier to noise ratio (CNR). The inventors have seen that by locating the land areas of the pit pattern around 0 and 180 degrees of a sinusoidal wobble the degrading effect to the wobble signal is minimized.

In an embodiment of the record carrier the pregroove modulation is synchronized to the wobble. The synchronization allows a detection system to first lock in on the wobble frequency, and subsequently detect the presence or absence of pregroove land areas, or vice versa. In a particular embodiment wobble periods that are representing said control information comprise less pregroove land areas than wobble period not representing said control information. This has the advantage that the wobble periods that are used to encode control information will have the original CNR, and errors during detecting the control information are prevented.

In an embodiment of the record carrier the pregroove modulation is representing recording control information. This has the advantage that a relatively large capacity for storing recording control data is created, e.g. easily around 1 bit for each wobble period. It is to be noted that traditional wobble modulation as described for example in WO00/43996 may require up to 100 wobble period for transferring a single bit.

Further preferred embodiments of the record carrier and device according to the invention are given in the further claims.

These and other aspects of the invention will be apparent from and elucidated further with reference to the embodiments described by way of example in the following description and with reference to the accompanying drawings, in which

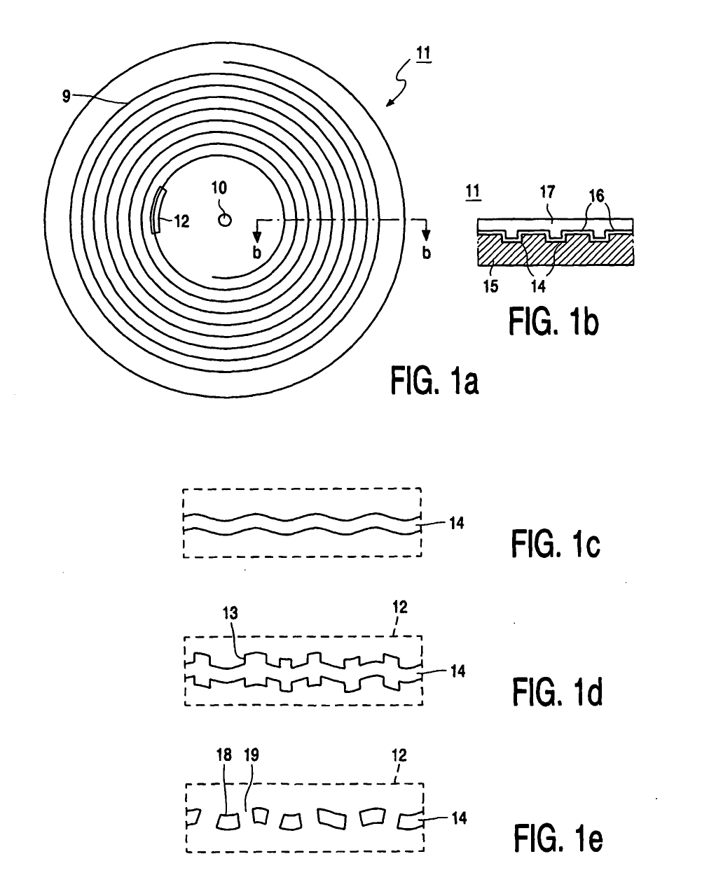

FIG. 1a shows a disc-shaped record carrier,

FIG. 1b shows a cross-section taken of the record carrier,

FIG. 1c shows an example of a wobble of the track,

FIG. 1d shows a wobble having a pregroove modulation by variations of the width,

FIG.1e shows a wobble having a pregroove modulation by variations of the depth,

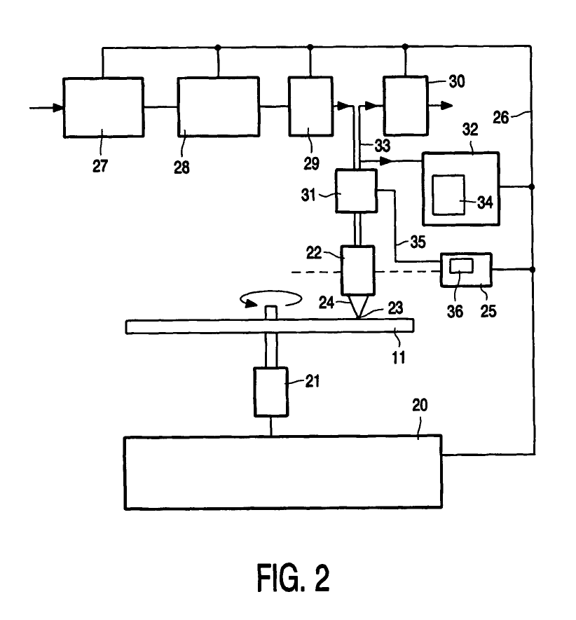

FIG. 2 shows a scanning device having pregroove demodulation,

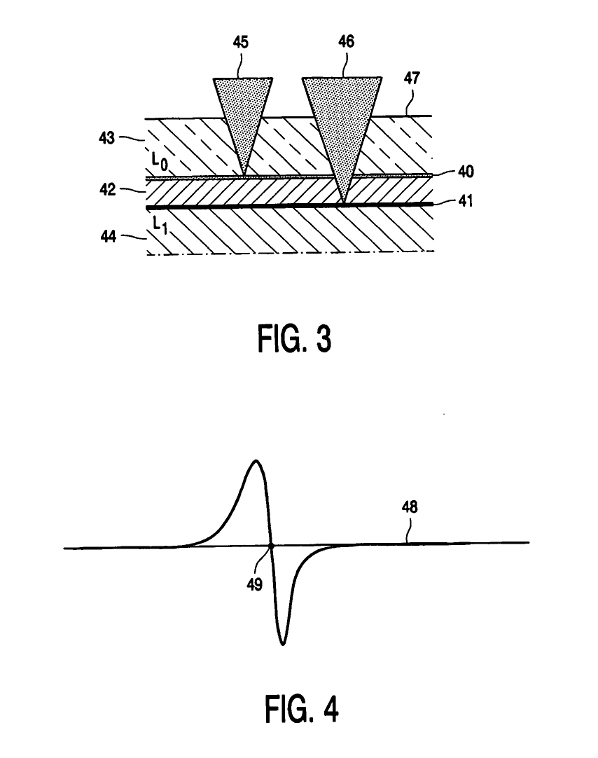

FIG. 3 shows a multilayer optical disc,

FIG. 4 shows the focus error signal S-curve,

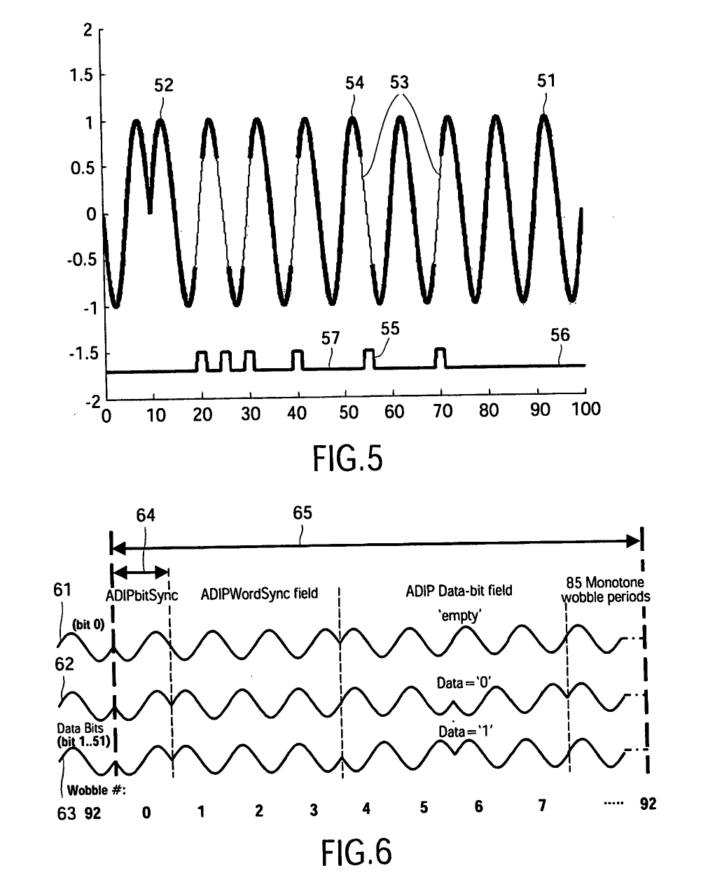

FIG. 5 shows wobble and a pregroove modulation read signal,

FIG. 6 shows ADIP information in wobble modulation,

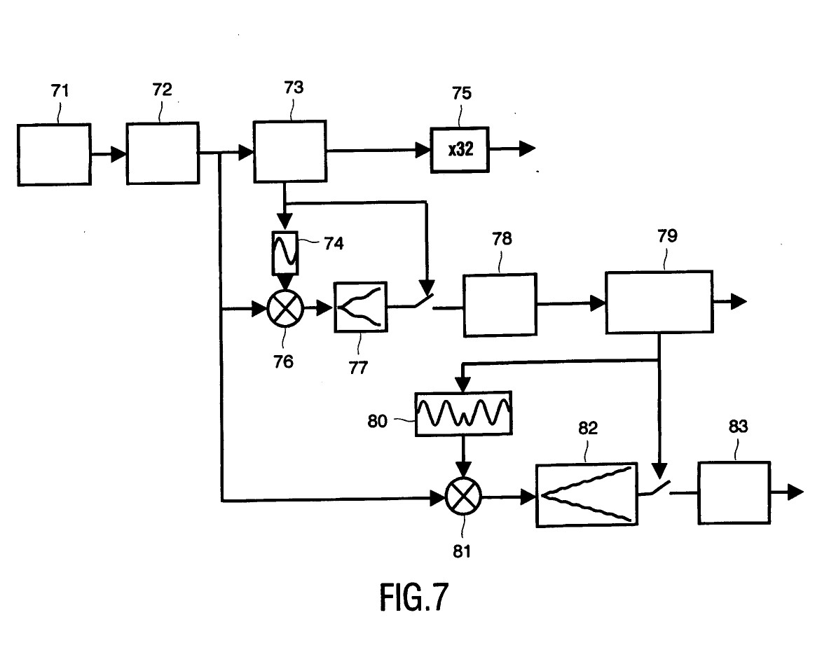

FIG. 7 shows a wobble demodulation unit, and

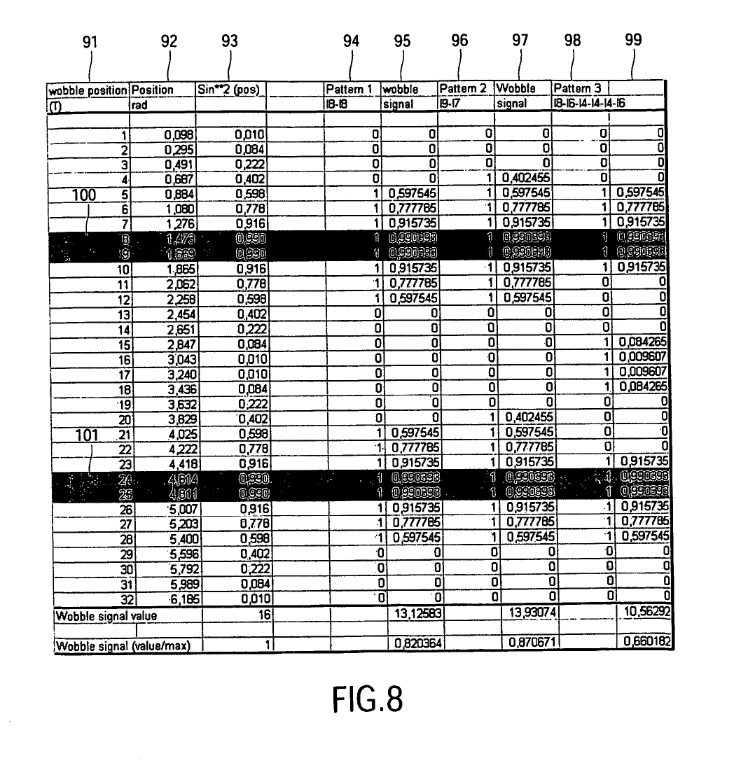

FIG. 8 shows a table of wobble signals for aligned pregroove modulation patterns.

In the Figures, elements which correspond to elements already described have the same reference numerals.

FIG. 1a shows a disc-shaped record carrier 11 having a track 9 and a central hole 10. The track 9 is arranged in accordance with a spiral pattern of turns constituting substantially parallel tracks on an information layer. The record carrier may be an optical disc having an information layer of a recordable type. Examples of a recordable disc are the CD-R and CD-RW, and the DVD+RW. The track 9 on the recordable type of record carrier is indicated by a pre-embossed track structure provided during manufacture of the blank record carrier, for example a pregroove. Recorded information is represented on the information layer by optically detectable marks recorded along the track. The marks are constituted by variations of a first physical parameter and thereby have different optical properties than their surroundings. The marks are detectable by variations in the reflected beam, e.g. variations in reflection.

FIG. 1b is a cross-section taken along the line b-b of the record carrier 11 of the recordable type, in which a transparent substrate 15 is provided with a recording layer 16 and a protective layer 17. The track structure is constituted, for example, by a pregroove 14 which enables a read/write head to follow the track 9 during scanning. The pregroove 14 may be implemented as an indentation or an elevation, or may consist of a material having a different optical property than the material of the pregroove. The pregroove enables a read/write head to follow the track 9 during scanning. A track structure may also be formed by regularly spread sub-tracks which periodically cause servo signals to occur. The record carrier may be intended to carry real-time information, for example video or audio information, or other information, such as computer data.

FIG. 1c shows an example of a wobble of the track. The Figure shows a periodic variation of the lateral position of the track, also called wobble. The variations cause an additional signal to arise in auxiliary detectors, e.g. in the push-pull channel generated by partial detectors in the central spot in a head of a scanning device. The wobble is, for example, frequency modulated and position information is encoded in the modulation. A comprehensive description of the prior art wobble as shown in FIG. 1c in a writable CD system comprising disc information encoded in such a manner can be found in U.S. Pat. No. 4,901,300 (PHN 12.398) and U.S. Pat. No. 5,187,699 (PHQ 88.002).

During readout by scanning the wobble modulation is detectable via a second type of variations of the radiation, such as variation of intensity in the cross section of the reflected beam detectable by detector segments or additional detectors for generating tracking servo signals. Detecting the wobble for a tracking servo system is well known from the above mentioned CD-R and CD-RW system. The wobble modulation is used to encode physical addresses, for example as shown in FIG. 6, while wobble demodulation is shown in FIG. 7.

User data can be recorded on the record carrier by marks having discrete lengths in unit called channel bits, for example according to the CD or DVD channel coding scheme. The marks are having lengths corresponding to an integer number of channel bit lengths T. The shortest marks that are used have a length of a predefined minimum number d of channel bit lengths T for being detectable via the scanning spot on the track that has an effective diameter, usually being roughly equal to the length of the shortest mark.

According to the invention the record carrier has a pregroove modulation constituted by variations of the depth or width of the pregroove that are aligned to the wobble period. The pregroove modulation is detectable during said scanning by variations of the reflected beam similar to the variations due to the marks in the track that are detectable by variations in the reflected beam, e.g. further variations in reflection. The alignment of the pregroove modulation to the wobble period is such that the areas of the pregroove that have a relative large depth and/or width are positioned around the peak values of the wobble lateral excursion, while pregroove land areas that are relatively narrow or shallow, in particular interrupting the pregroove and therefore having a zero depth for being equal to the surrounding level of the recording layer, are positioned around the zero crossings of the wobble. Hence the wobble signal will be close to a wobble signal of a continuous pregroove.

In an embodiment the record carrier has an auxiliary control area 12 in which the pregroove is modulated for encoding auxiliary control information. In the auxiliary control area 12 the pregroove exhibits a pregroove modulation constituted by variations of a physical parameter related to the shape of the pregroove for representing auxiliary control information.

In an embodiment the auxiliary control area 12 is located at a predefined position on the recording layer. The predefined position is indicated schematically as a part of the track 9 by the rectangle 12 in the Figure, but in practice the auxiliary control area 12 has sufficient length for allowing the auxiliary control information to be encoded, e.g. a few windings of the track. In particular the predefined position may cover a predefined radial range to allow a device to locate the area based on the radial positioning of the optical head without the need to read the addresses in the track.

In an embodiment the auxiliary control area 12 is also arranged as a focus area provided for performing a focus adjustment procedure as discussed below for setting a best focus offset, which results in a low jitter in the read-out signal of the user data. The focus area is provided with a carrier pattern of long marks during manufacture of the record carrier. The carrier pattern is a series of prewritten marks that are long compared to the length of the shortest mark used for user data encoding for being substantially longer than the effective diameter of the scanning spot. In particular the long pregroove marks have lengths of at least two times the predefined minimum number d of channel bit lengths T. The carrier pattern may be constituted by long pregroove marks having a single length, or may be a predefined pattern using a few lengths, or may be randomly varied or may be modulated for encoding the auxiliary control information.

In an embodiment of the invention the shortest marks for recording the main information have a length of a 3 channel bit lengths, usually denoted as d=3T or 3I. For example in DVD the channel code is an RLL (2,10) code having a minimum length of 3T, and a maximum length of 11T, while marks of 14T are used for synchronization. In such a system the long marks have at least a length of 6T or 7T, but preferably have lengths of at least 8T. A practical single tone carrier pattern has long marks of a single size, e.g. pits and intermediate lands having a length of 11T. It is noted that for a wobble corresponding to a predefined number of channel bit lengths suitable pregroove mark lengths are selected to constitute a pattern fitting that predefined number. Suitable ranges of lengths for encoding information in the long marks are a range of 6T to 14T, or 10T to 12T. For a wobble of 32 channel bits like in DVD+RW, a suitable length is 8T pregroove pits alternating with 8T pregroove lands, as such a pattern can be perfectly aligned to the sine wave as shown in FIG. 8.

FIG. 1d shows a wobble having a pregroove modulation by variations of the width. The Figure shows the wobbled pregroove 14 having a pregroove modulation 13. The shape of the pregroove, being the local cross-sectional shape, is changed according to an additional information signal to be encoded. Such change in shape affects the radiation reflected from the track during scanning, and can be detected thereby. As shown in the Figure the width of the pregroove is modulated according to a digital modulation pattern.

FIG. 1e shows a wobble having a pregroove modulation by variations of the depth. As shown the depth is varied digitally for constituting pregroove pit areas 18 having a predefined depth and pregroove land areas 19 having a zero depth (i.e. no pregroove is present). Other variations of depth may be used instead.

For manufacture of such a record carrier a master disc is made. During the mastering process, the pregroove is written by a laser beam recorder. The wobble is made by imposing a small lateral offset of the nominal center position of the track, and the intensity of the laser power of the mastering laser beam is further modulated to provide the pregroove shape modulation.

The pregroove (width, depth) modulation along the track is used to generate an additional data channel. The unrecorded disc (R or RW type) then contains additional mastered data, for example recording control data. The auxiliary data may be encoded using a channel code similar or equal to the channel code used to encode the main user data. This has the advantage that no additional circuitry is needed for decoding the additional data. In an embodiment a different modulation is used, i.e. a channel modulation code differing from the channel code used to encode the main user data. This allows any modulation to be used for encoding information in the pregroove that is optimized for not disturbing the other properties of the pregroove, e.g. a modulation having ‘constant length pulses’ encoding the additional data by the position of the pulses. Main user data, also called high-frequency data, may be superimposed on the modulated pregroove. The additional data in the pregroove can be run length-modulated, frequency-modulated, amplitude-modulated, phase-modulated, or any other modulation scheme, which ever is best to distinguish the data from superimposed high-frequency main user data.

In an embodiment of the record carrier of the DVD+R or +RW type the pregroove modulation is applied in a guard or buffer zone in the lead-in zone (other places could be middle zone, lead out zone). The continuous pregroove is replaced by pregroove pits and lands of either a single tone or multiple tones. It is noted that the ADIP information obtained from the groove is still present and can be read. As an example a two-layer Opposite Track Path DVD+R disc is used. The pregroove pits and lands are placed in the guard zone 3 of the lead in zone of the L0 disc (closest to the laser) and in the lead out zone of the L1 layer (below the lead-in zone of the L0 disc).

In an embodiment of the record carrier windings of the track having the pregroove modulation are alternated with windings of the track having no pregroove modulation or having a different, predefined pregroove modulation. By such a pattern the so-called wobble beat and/or crosstalk of adjacent grooves can be minimized.

FIG. 2 shows a scanning device having pregroove demodulation. The device is provided with means for scanning a track on a record carrier 11 which means include a drive unit 21 for rotating the record carrier 11, a head 22, a servo unit 25 for positioning the head 22 on the track, and a control unit 20. The head 22 comprises an optical system of a known type for generating a radiation beam 24 guided through optical elements focused to a radiation spot 23 on a track of the information layer of the record carrier. The radiation beam 24 is generated by a radiation source, e.g. a laser diode. The head further comprises (not shown) a focusing actuator for moving the focus of the radiation beam 24 along the optical axis of said beam and a tracking actuator for fine positioning of the spot 23 in a radial direction on the center of the track. The tracking actuator may comprise coils for radially moving an optical element or may alternatively be arranged for changing the angle of a reflecting element. The focusing and tracking actuators are driven by actuator signals from the servo unit 25. For reading the radiation reflected by the information layer is detected by a detector of a usual type, e.g. a four-quadrant diode, in the head 22 for generating detector signals coupled to a front-end unit 31 for generating various scanning signals, including a main scanning signal 33 and error signals 35 for tracking and focusing. The error signals 35 are coupled to the servo unit 25 for controlling said tracking and focusing actuators. The error signals 35 are also coupled to a wobble demodulation unit 36 for retrieving the physical addresses from the wobble modulation. A detailed embodiment of wobble detection is given in FIG. 7. The main scanning signal 33 is processed by read processing unit 30 of a usual type including a demodulator, deformatter and output unit to retrieve the information.

The control unit 20 controls the scanning and retrieving of information and may be arranged for receiving commands from a user or from a host computer. The control unit 20 is connected via control lines 26, e.g. a system bus, to the other units in the device. The control unit 20 comprises control circuitry, for example a microprocessor, a program memory and interfaces for performing the procedures and functions as described below. The control unit 20 may also be implemented as a state machine in logic circuits. In an embodiment the control unit performs the functions of retrieving the additional information from the pregroove via the read processing unit 30.

The device has a pregroove demodulation unit 32 for detecting pregroove modulation in the scanning signal as follows. The main scanning signal 33 is received from the front-end unit 31. Components in the signal 33 due to the marks of the main information are removed and components due to the marks of the pregroove modulation are isolated. In an embodiment the demodulation unit has a filter unit 34 that has a low pass or band pass function specifically tuned to the long marks. Auxiliary control information is retrieved from the pregroove modulation by the pregroove demodulation unit 32. Timing recovery for reconstructing a data clock of the auxiliary signal can be based on the wobble frequency or on the pregroove modulation itself. In an embodiment timing recovery is based on the data clock retrieved for the main data. Synchronous detection can be applied for detecting the data bits of the auxiliary data. In an embodiment the pregroove modulation is provided with a channel code and/or error correction codes different from the channel codes used in the user data, and the demodulation unit 34 is provided with a dedicated channel code demodulator and/or error correction unit

In an embodiment the device is provided with recording means for recording information on a record carrier of a writable or re-writable type, for example CD-R or CD-RW, or DVD+RW or BD. The recording means cooperate with the head 22 and front-end unit 31 for generating a write beam of radiation, and comprise write processing means for processing the input information to generate a write signal to drive the head 22, which write processing means comprise an input unit 27, a formatter 28 and a modulator 29. For writing information the beam of radiation is controlled to create optically detectable marks in the recording layer. The marks may be in any optically readable form, e.g. in the form of areas with a reflection coefficient different from their surroundings, obtained when recording in materials such as dye, alloy or phase change material, or in the form of areas with a direction of polarization different from their surroundings, obtained when recording in magneto-optical material.

Writing and reading of information for recording on optical disks and formatting, error correcting and channel coding rules are well-known in the art, e.g. from the CD or DVD system. In an embodiment the input unit 27 comprises compression means for input signals such as analog audio and/or video, or digital uncompressed audio/video. Suitable compression means are described for video in the MPEG standards, MPEG-1 is defined in ISO/IEC 11172 and MPEG-2 is defined in ISO/IEC 13818. The input signal may alternatively be already encoded according to such standards.

FIG. 3 shows a multilayer optical disc. L0 is a first recording layer 40 and L1 is a second recording layer 41. A first transparent layer 43 covers the first recording layer, a spacer layer 42 separates both recording layers 40,41 and a substrate layer 44 is shown below the second recording layer 41. The first recording layer 40 is located at a position closer to an entrance face 47 of the record carrier than the second recording layer 41. A laser beam is shown in a first state 45 focused on the L0 layer and the laser beam is shown in a second state 46 focused at the L1 layer. Each recording layer has the pattern of pregroove marks that encodes auxiliary control information.

Multilayer discs are already available as read-only pre-recorded discs, such as DVD-ROM or DVD-Video. A dual layer DVD+R disc has recently been suggested, which disc should preferably be compatible with the dual layer DVD-ROM standard. The reflection levels of both layers are >18%. The L0 layer has a transmission around 50-70%. A spacer layer separates the layers with a typical thickness between 30 and 60 μm. The L1 layer has a high reflection and needs to be very sensitive. Also rewritable dual-layer discs are proposed. The L0 layer has a transmission around 40-60%. The effective reflection of both layers is typically 7% although lower and higher values are possible (3%-18%). Writable and rewritable optical storage media having 3 or more recording layers are considered also.

FIG. 4 shows the focus error signal S-curve. The focus error signal 48 is shown for a focus varied from below to above a recording layer. For example in single layer +RW and ROM, the optimal focus-offset is found by keeping the focus-error at the zero crossing 49 of the S-curve. Additional fine-tuning may be provided by optimizing on pre-recorded data (in the case of the ROM disc). In dual layer DVD-ROM (DVD-9), the optimal focus-offset is found by keeping the focus-error at the zero crossing of the S-curve and then further optimizing on jitter. Here, the optimal focus-offset suffers from stray light from the other out-of focus layer and/or thickness variations of the substrate but this can be compensated by optimizing on jitter. In dual layer DVD+R/+RW no pre-recorded data is available to optimize the jitter values.

In an embodiment the device has a focus adjustment function included in the focus servo unit 25. First a focus area constituted by an area of the pregroove having the pregroove modulation is detected. Then the best focus is detected by scanning the carrier pattern in the focus area and monitoring the amplitude of the scanning signal due to said long marks. In particular a maximum of the amplitude is found by varying the focus offset. The focus adjustment unit may also be implemented as a software function in the control unit 20, using the read circuitry available in the read unit 30 for detecting the amplitude of the signal due to the long pregroove marks. In an embodiment the focus adjustment function is performed for a multilayer disc for each of the relevant layers separately. The focus area on the respective layer is located, and the further steps are performed as indicated above for the first layer. Finding the right focus offset is important for writing recordable and rewritable discs. With a non-optimal focus offset the data is written on the disc in a non-optimal manner, leading to increased write power and jitter values (especially during read out).

FIG. 5 shows wobble and a pregroove modulation read signal. The x-axis shows time and the y-axis shows the signal values. An upper curve shows the wobble 51 as a signal deviating in a radial direction from a nominal zero position. The phase of the wobble is modulated for encoding physical addresses as indicated by the phase reversal constituting wobble modulation 52. The wobble modulation represents physical address information indicating the physical position of the respective physical address with respect to a starting point of the track The wobble modulation is known for example from DV+RW and is described in detail in WO00/43996. According to the invention the pregroove constituting the wobble is modulated by alternating pregroove land areas 53 and pregroove pit areas 54. The lower curve 56 shows the resulting read signal usually called central aperture (CA) signal generated by a detector in the read head. The signal is caused by the difference in reflection of pregroove pits (groove reflection level) and pregroove lands (mirror type reflection level). The signal is comparable to the difference in reflection between a groove and a mirror area on the disc (typically 10-15% of the reflection level). Alternatively other methods can be employed for read out, e.g. radial and tangential push pull. It is noted that the wobble period or modulation cannot be detected from the CA read signal, but the pregroove land areas 53 result in pulses 55 in the CA signal, while the intermediate signal parts 57 are interpreted as being due to pregroove pits. Demodulating the pregroove signal elements 55, 57 due to the pregroove modulation is relatively straightforward. In an embodiment the pregroove signal elements are directly linked to the wobble PLL clock. Simple filtering and threshold detection can be employed. When the pits are large (>8T), inter symbol interference is negligible and the frequency and the magnitude of the signal are fixed. Channel bits demodulated from the signal are decoded to the auxiliary information according to a channel coding algorithm, for example the same channel coding as used for the main data in the CD or DVD system. In an embodiment a dedicated channel coding algorithm is used for encoding the auxiliary information in the pregroove land and pit areas, which algorithm for example only uses pregroove mark lengths of 10 to 14 channel bits.

FIG. 6 shows ADIP information in wobble modulation. The wobble modulation encodes additional information that is called Address In Pregroove (ADIP) in the DVD+RW system. Each ADIP bit 65 is constituted by ADIP bit sync (one wobble period 64 corresponding to 32 channel bits), followed by a ADIP word sync field (3 wobble periods) and the ADIP Data-bit field of 4 wobble periods, followed finally by 85 monotone (i.e. not modulated) wobble periods. The Figure shows a first wobble 61 which is encoded as an ADIP word sync, in which the word sync field has inverted wobbles and the data-bit field has non modulated wobbles. Second wobble 62 encode a data bit value 0 and third wobble 63 encodes a data bit of value 1.

In an embodiment the pregroove modulation is aligned to the ADIP modulation, in particular wobble periods that are used for encoding ADIP data are not modulated by the pregroove modulation, while wobble period that are not used in ADIP encoding are used for pregroove modulation. It is noted that inverted wobbles can only be present in bit position 0, bit positions 4 to 7 and in the special situation of an ADIP bit sync in bit positions 1 to 3. For reliable wobble detection those bit positions are most important, and the wobble signal amplitude for inverted wobbles should be not decreased. Hence the pregroove modulation is omitted from inverted or from all ADIP encoding wobbles.

It is noted that the alignment of pregroove pits and lands to the wobble period can be applied in all formats using wobbled pits, and especially in those formats where relatively high frequency wobbles are used.

FIG. 7 shows a wobble demodulation unit. The input unit 71 provides a push-pull signal derived from the head scanning the track. A filter 72 filters the signal by high pass and low pass filters for isolating the wobble frequency and generating a wobble signal. A phase locked loop 73 is locked to the wobble frequency, and generates via a 32x multiplier 75 the synchronous write clock for recording marks in units of channel bits. A synchronous wobble unit 74 provides a wobble clock period to multiplier 76 which also receives the wobble signal. The output of the multiplier 76 is integrated in integrate and dump unit 77, of which the output is samples via a sample switch to a sync threshold detector 78 coupled to a ADIP bit synchronizer that detects the ADIP bit syncs. A second multiplier 81 is provided with a 4 wobble period signal having two inverted and two non inverted wobbles and the wobble signal on a second input for synchronous detection over 4 wobble periods. A second integrate and dump unit 82 integrates output signal of the multiplier 82, while a bit value threshold detector 83 for detecting the values of the encoded bits.

The way the signal level is build during detection is by multiplying a sine wave from the wobbled groove with a sine wave from the wobble PLL. During a single wobble period, the contribution to the wobble signal is far from linear. At 90 degrees and 270 degrees of the wobble period, the contribution is largest. So, these positions should be used to place wobbled pits. At 0 degrees, 180 degrees and 360 degrees no wobble signal is generated, so these positions must be used for the lands between the pits. In case a is the phase of the sine wave, the wobble signal is proportional to sin²(α). So, by proper placing the pits on the phase of the wobble, a wobbled pit signal can be obtained with optimum amplitude.

FIG. 8 shows a table of wobble signals for aligned pregroove modulation patterns. In a first column 91 “wobble position” the wobble period is subdivided in channel bit units. In a second column 92 “position in rad” the phase of the wobble (one full sine wave) is expressed in radians. In a third column 93 “sin**2(pos)” the value of the wobble amplitude in indicated by a squared sine function. In the fourth column 94 “Pattern 1 I8-I8” a first pattern of pregroove lands (value=0) and pregroove pits (value=1) is indicated that constitutes a first example of an aligned pregroove modulation. The gray area 100 indicates the positive peak value of the wobble sine wave, while the second gray area 101 indicates the negative peak value of the wobble sine wave. The first pattern has pregroove pits (value=1) aligned with the peak values indicated by the gray areas, while the pregroove lands (value=0) are aligned with the zero crossings of the wobble sine wave. At the bottom of third column 93 the sum of the contributions of each wobble signal value is given, i.e. 16 which is normalized to value 1 in the next row. The first pattern is an I8 pit-I8 land carrier frequency. The fifth column 95 shows the contributions of the pregroove wobble only for those areas where the pregroove pits for the first pattern are positioned, resulting in a normalized sum of about 0.82, i.e. 82% of the wobble signal of a normal continuous pregroove value. The sixth column 96 “Pattern 2 I9-I7” shows a second pattern having pits of length 9 and lands of length 7 around the zero crossings of the wobble sine wave. The seventh column 97 shows contributions of the pregroove wobble only for those areas where the pregroove has pits for the second pattern, resulting in a normalized sum of about 0.87, i.e. 87% of the normal continuous pregroove value. The eighth column 98 “Pattern 3 I8-I6-I4-I4-I4-I6” shows a third pattern having pits and lands of the lengths as indicated. Relative long pits are located around the maxima of the wobble sine wave. The ninth column 99 shows contributions of the pregroove wobble only for those areas where the pregroove has pits for the third pattern, resulting in a normalized sum of about 0.66, i.e. 66% of the normal continuous pregroove value. It is to be noted that a completely random, non aligned, but DC free pattern would result in 50% of the normal continuous pregroove wobble signal, and in worst case (pits aligned to zero crossings) an even lower signal may occur.

In an embodiment a more random data pattern in neighboring tracks on the disc is provided. It is noted that other properties of the wobble signal, e.g. the jitter when detecting the pre-pits, may be used for detecting the best focus offset. The offset value will be influenced via crosstalk by the pregroove patterns in neighboring tracks, in particular if such patterns are aligned. Hence a quasi random pattern having an improved wobble signal output can be generated by making use of shift of the wobble positions in the neighbor tracks. For instance, in DVD+R double layer, the track pitch is 0.74 micron, so track n+1 is 0.74×2×PI=4.65 micron longer as compared to track n. This corresponds almost precisely with one wobble period, being 32×0.147=4.70 micron. This means that wobbles are aligned from track to track; an even wobble will always have odd wobbles in the neighboring tracks. Now the patterns of pregroove modulation can be varied from track to track. For example, by using alternating Pattern 1 and Pattern 3 from FIG. 8, a quasi random pattern on the disc can be obtained, while still having a good wobble signal of (82+66)/2=74% of its maximum value. For even more random distributions also a combination of for instance four different patterns can be used.

Although the invention has been mainly explained by embodiments using optical discs based on change of reflection, the invention is also suitable for other record carriers such as rectangular optical cards, magneto-optical discs or any other type of information storage system that has a pre-applied pattern on a writable record carrier. It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software. Further, the scope of the invention is not limited to the embodiments, and the invention lies in each and every novel feature or combination of features described above.

1. Record carrier of a writable type for recording information by writing marks in a track on a recording layer via a beam of radiation entering through an entrance face of the record carrier and constituting a scanning spot having an effective diameter on the track,
the recording layer comprising a pregroove indicating the position of the track, the pregroove exhibiting a wobble constituted by periodical displacements of the pregroove in a direction transverse to the longitudinal direction of the track, the wobble exhibiting a wobble modulation for representing control information, and
the pregroove comprising a pregroove modulation constituted by pregroove pit areas having a predefined width and depth alternating with pregroove land areas having a reduced depth and/or width, in particular zero depth,
a majority of the pregroove land areas being located at zero crossings of the wobble and a majority of the pregroove pit areas being located at peak values of the wobble.

2. Record carrier as claimed in claim 1, wherein the pregroove modulation is synchronized to the wobble, in particular wobble periods that are representing said control information comprising less pregroove land areas than wobble period not representing said control information.

3. Record carrier as claimed in claim 1, wherein the pregroove modulation is representing recording control information.

4. Record carrier as claimed in claim 3, wherein the recording control information is encoded by the pregroove land areas and pregroove pit areas according to a predefined channel coding algorithm, which predefined channel coding algorithm differs from a main channel coding algorithm for the marks representing said information.

5. Record carrier as claimed in claim 1, wherein the record carrier comprises at least a first recording layer (L0) and a second recording layer (L1), the first recording layer being present at a position closer to the entrance face than the second recording layer, and each recording layer having the pregroove.

6. Record carrier as claimed in claim 1, wherein the marks have lengths corresponding to an integer number of channel bit lengths T and the shortest marks having a length of a predefined minimum number d of channel bit lengths T for being detectable via the scanning spot having said effective diameter, and the pregroove land areas and pregroove pit areas have lengths of at least two times the predefined minimum number d of channel bit lengths T for being substantially longer than the effective diameter of the scanning spot.

7. Record carrier as claimed in claim 6, wherein the predefined minimum number d is 3 channel bit lengths T (d=3T), and the long marks have lengths of at least 6T, in particular the lengths being in the range of 8T to 14T.

8. Record carrier as claimed in claim 1, wherein the pregroove modulation is different in neighboring tracks for preventing alignment of pregroove land and pit areas in adjacent pregroove parts, in particular adjacent pregroove parts having quasi random pregroove modulation or pregroove parts being not modulated neighboring to modulated pregroove parts.

9. Device for scanning a track on a record carrier (11) via a beam of radiation (24), the track comprising marks on a recording layer, the beam entering through an entrance face of the record carrier and constituting a scanning spot having an effective diameter on the track, the recording layer comprising a pregroove indicating the position of the track, the pregroove exhibiting a wobble constituted by periodical displacements of the pregroove in a direction transverse to the longitudinal direction of the track, the wobble exhibiting a wobble modulation for representing control information, and the pregroove comprising a pregroove modulation that represents recording control information and is constituted by pregroove pit areas having a predefined width and depth alternating with pregroove land areas having a reduced depth and/or width, in particular zero depth, a majority of the pregroove land areas being located at zero crossings of the wobble and a majority of the pregroove pit areas being located at peak values of the wobble, the device comprising
a head (22) for providing the beam,
wobble detection means for retrieving the control information from the wobble modulation, and
pregroove demodulation means for retrieving the recording control information from the pregroove modulation.

10. Device as claimed in claim 9, wherein the pregroove demodulation means comprise synchronization means coupled to the wobble detection means for synchronizing detection of the pregroove land areas and pregroove pit areas to the wobble period.
